(19) United States
(12) Patent Application Publication
(10) Pub. No.: US 2026/0181016 A1
(43) Pub. Date: Jun. 25, 2026

(54) LINKED RESOURCE REFERENCE REPLACEMENT IN A MESSAGE

(71) Applicant: Abnormal AI, Inc., Las Vegas, NV (US)

(72) Inventors: Sanjay Jeyakumar, El Cerrito, CA (US); Abhijit Bagri, Atlanta, GA (US); Alethea Toh, Jersey City, NJ (US); Andrew Schloss, Boston, MA (US); De Sheng Chuan, Singapore (SG); Yu Ning, Singapore (SG); Yu Zhou Lee, San Francisco, CA (US)

(21) Appl. No.: 18/991,941

(22) Filed: Dec. 23, 2024

(51) Int. Cl. H04L 9/40; H04L 51/212

(52) U.S. Cl. CPC H04L 63/1483; H04L 51/212; H04L 63/1416

(57) ABSTRACT

A message is received and one or more linked resource references included in the message are identified. For a specific linked resource reference included in the one or more linked resource references, a threat score is determined based at least in part on one or more attributes of the specific linked resource reference. A determination is made that the threat score satisfies a replacement criterion. The specific linked resource reference is replaced for the message with a replacement linked resource reference to an interstitial resource. One or more user interactions with the replacement linked resource reference are tracked. A security action is performed based on the tracked one or more user interactions.

### BACKGROUND OF THE INVENTION

Email protection systems safeguard against various types of email threats. Example threats can include spam, phishing, malware, and data breaches. Typically, email protection systems examine incoming email such as by passing incoming email through a filter that uses different criteria to evaluate its legitimacy. The evaluation can include examining the sender's reputation, email headers, and the contents of the email. For example, the contents of the email can be examined by identifying keywords in the subject line associated with malicious emails and/or by flagging all outbound links included in the email body. Based on the email examination results, a user can be presented with actionable information including by labelling or even modifying potentially dangerous emails. However, these preventative approaches typically apply solutions on an entire email and their lack of granularity can introduce false positives and negatives. For example, link rewriting is typically performed without consideration for email context resulting in overly aggressive measures that impact the user experience while also masking links that are true security threats. As email attacks grow increasingly sophisticated and rich-text or HTML-based emails with embedded links become more common, there is a need for improved email protection systems that can apply context-based safeguards to mitigate threats posed by emails with embedded malicious links.

### BRIEF DESCRIPTION OF THE DRAWINGS

Various embodiments of the invention are disclosed in the following detailed description and the accompanying drawings.

FIG. 1 is a block diagram illustrating an embodiment of a threat detection system for analyzing messages.

FIG. 2 is a block diagram illustrating an embodiment of a threat detection system for analyzing messages for linked resource references.

FIG. 3 is a flow chart illustrating an embodiment of a process for performing threat detection by analyzing messages for linked resource references.

FIG. 4 is a flow chart illustrating an embodiment of a process for analyzing linked resource references embedded within messages for security threats.

FIG. 5 is a flow chart illustrating an embodiment of a process for responding to a linked resource reference identified as a potential security threat.

FIG. 6 is a flow chart illustrating an embodiment of a process for utilizing an interstitial resource as a response to a linked resource reference identified as a security threat.

FIG. 7 is a flow chart illustrating an embodiment of a process for scoring a linked resource reference identified in a message.

FIG. 8 is a flow chart illustrating an embodiment of a process for automatically generating a threat detection report.

FIG. 9 is a functional diagram illustrating a programmed computer system for detecting and mitigating security threats related to linked resource references in messages.

FIG. 10 is an example of a user interface view for displaying a message with a replacement linked resource reference.

FIG. 11 is an example of a user interface view for displaying an interstitial resource accessed via a replacement linked resource reference.

FIG. 12 is an example of a user interface view for displaying threat detection result reports from analyzing a message for malicious linked resource references.

FIG. 13 is an example of a user interface view for displaying threat detection result reports from analyzing a message for malicious linked resource references.

FIG. 14 is an example of a user interface view for configuring threat detection analysis for malicious linked resource references in messages.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Linked resource reference analysis by a threat detection system is disclosed. For example, using the disclosed techniques and systems, linked resource references embedded in messages such as email messages are analyzed to identify and mitigate potential threats. The linked resource references can be embedded uniform resource locations (URLs) referencing resources such as websites, email addresses, files, or other resources including remote resources. The linked resource references are analyzed based on the specific context of each reference and each is assigned a potentially unique threat score. By individually analyzing linked resource references, each linked resource reference can be treated uniquely even when multiple references are found in the same message. For example, a reference to an authorized corporate website found in an email signature can be treated differently than a phishing or malware reference found in the body of the email. In various embodiments, the threat score is determined based on attributes of the specific linked resource reference such as the domain name, whether a reference shortener is used, whether authentication is used, and past knowledge of the reference, among other attributes. Linked resource references that meet a replacement criterion can be replaced with a replacement linked resource reference, which can route the user to an interstitial resource such as an intermediate landing page where security actions can be performed. For example, a customized intermediate landing page can provide the user with the appropriate warnings and details of the replaced linked resource reference while also allowing the user to proceed with the appropriate knowledge to the original linked resource reference. The interstitial resource can also be used to track and monitor user interactions to the original linked resource reference. For example, one or more interstitial landing pages can be used to track how frequent different users visit the same linked resource reference. The tracked data can be used to inform what future security actions should be taken on the same or similar linked resource reference and/or on emails that include the same or similar linked resource reference. For example, models used by a threat detection system can be trained on the tracked user interactions to proactively detect emails with similar linked resource references. Once detected, the appropriate security action can be taken.

In some embodiments, a message is received. For example, an email message is received by a threat detection system as part of a process to analyze emails for security threats. One or more linked resource references included in the message are identified. For example, links or URLs embedded within the email that reference a resource such as a website are identified. For a specific linked resource reference included in the one or more linked resource references, a threat score based at least in part on one or more attributes of the specific linked resource reference is determined. For example, a threat score is determined for each identified link or URL based on attributes of each specific link. Rather than applying the same solution to all links, each identified link has its own determined threat score allowing the threat detection system to distinguish between good and bad links within the same email.

In some embodiments, a determination is made whether the threat score satisfies a replacement criterion. For example, the threat score for a specific link can be compared to a threshold value configured to trigger additional processing of the link such as the replacement or rewriting of the link. In some embodiments, the specific linked resource reference is replaced for the message with a replacement linked resource reference to an interstitial resource. For example, the identified link that satisfies the replacement criterion is replaced or rewritten with a replacement linked resource reference. The interstitial resource referenced by the replacement can be an intermediate landing webpage that contains additional details of the identified link and allows the user to proceed to access the original linked resource with the appropriate precautions. In some embodiments, one or more user interactions with the replacement linked resource reference are tracked. For example, when a user accesses the replacement linked resource reference, the threat detection system can track an intent to access or learn more about the original linked resource. In some embodiments, a security action based on the tracked one or more user interactions is performed. For example, using tracked user interactions and associated metrics, security actions can be performed to minimize potential security threats such as by providing a warning message to the user ahead of access to the identified link, providing threat analysis details on the identified link to the user, and providing security updates to a security administrator on the potential user access of a potentially malicious link. In some embodiments, the tracked user interactions are further used to train the threat detection system and/or to inform the threat detection system to identify identical or similar linked resource references in other messages including future and/or past messages.

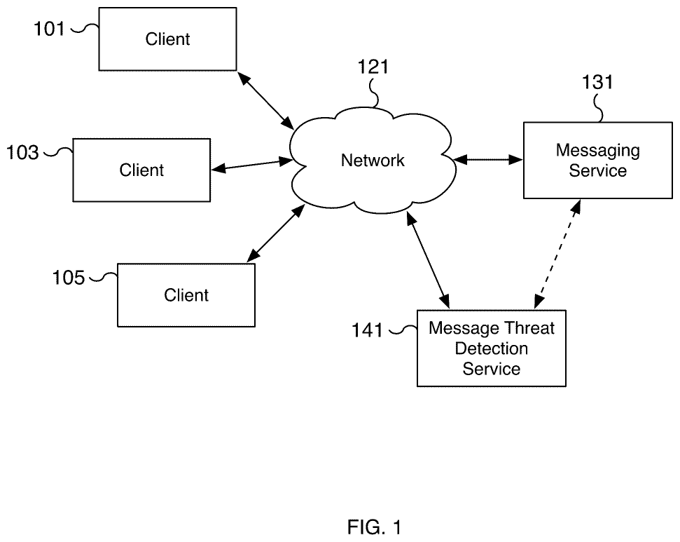

FIG. 1 is a block diagram illustrating an embodiment of a threat detection system for analyzing messages. In the example shown, messages provided via messaging service 131 for clients such as clients 101, 103, and 105 are analyzed by message threat detection service 141 for threats presented by linked resource references. Clients 101, 103, and 105 are communicatively connected to messaging service 131 and/or message threat detection service 141 via network 121. Similarly, message threat detection service 141 is communicatively connected to messaging service 131 via network 121. Network 121 can be a public or private network. In some embodiments, network 121 is a public network such as the Internet. In various embodiments, clients such as clients 101, 103, and/or 105 can access messaging service 131 to fulfill messaging requirements such as sending and receiving messages. Message threat detection service 141 monitors and analyzes the messages, identifying and mitigating threats posed by embedded linked resource references. In some embodiments, message threat detection service 141 accesses messages for a monitored client by directly accessing messaging service 131 for messages on behalf of the client and/or by directly accessing messages on the client, such as by directly accessing a message application running on a client such as client 101, 103, or 105. In various embodiments, message threat detection service 141 identifies threats posed by linked resource references and can initiate security actions such as the replacement of a potentially threatening linked resource reference. The monitoring and actions performed by message threat detection service 141 can be presented as reports. Example reporting mechanisms can include email reports, notifications, and online interactive reports such as via a dashboard.

In some embodiments, clients 101, 103, and 105 are each a network client device for interfacing with messaging service 131 and/or message threat detection service 141. For example, clients 101, 103, and/or 105 can correspond to users of an organization configured to access a messaging service such as an email service offered by messaging service 131. As another example, clients 101, 103, and/or 105 can correspond to information security personnel or other users with authorized security credentials that utilize message threat detection service 141 for performing security responsibilities, including managing threat detection for supported messaging services such as messaging service 131. For example, clients corresponding to an authorized security administrator can configure message threat detection service 141 and/or access threat detection reports from message threat detection service 141. In some embodiments, clients 101, 103, and/or 105 can further correspond to one or more compromised clients capable of sending a message via messaging service 131 with malicious linked resource references.

In some embodiments, messaging service 131 is a cloud-based platform for providing messaging services. Examples of messaging services can include email, group or workplace chat or communication services, text and/or multimedia messaging services, and instant messaging services, among others. Although only a single messaging service 131 is shown in FIG. 1, multiple messaging services can be supported, such as different email services and/or one or more email services along with other messaging services, such as a group chat service. In various embodiments, messages sent via messaging service 131 are analyzed for potential threats associated with embedded linked resource references by message threat detection service 141.

In some embodiments, message threat detection service 141 is a threat detection system for detecting and mitigating threats associated with embedded linked resource references in messages. For example, message threat detection service 141 can ingest messages sent and/or received by messaging service 131. In some embodiments, the messages are retrieved from messaging service 131 and/or by directly accessing the messages from clients. The messages are analyzed, and each linked resource reference included in a message is analyzed to determine a threat score. Based on the threat score meeting a replacement criterion, the linked resource reference can be replaced with a replacement linked resource reference that forwards the user to an interstitial resource. Using the interstitial resource, user interaction to the linked resource reference can be tracked and the security action can be initiated. For example, future emails with similar links can be identified as malicious based on the tracked user interactions. In some embodiments, the interstitial resource allows the user to continue from the interstitial resource to the linked resource, for example, by acknowledging the potential risk posed by the linked resource. Moreover, the interstitial resource may be customized for each linked resource reference. For example, a custom interstitial resource for a particular linked resource reference can provide details on the linked resource including potential warning characteristics that suggest the linked resource may be malicious and/or a security threat.

In various embodiments, message threat detection service 141 can further provide reports on threat detection results to users such as security personnel. For example, message threat detection service 141 can provide automated reports including notifications and/or email reports based on detected malicious linked resource references and/or tracked user interactions with linked resource references. In some embodiments, message threat detection service 141 provides a dashboard such as an interactive dashboard for reviewing and managing detected threats based on linked resource references identified in analyzed messages.

Although single instances of some components have been shown to simplify the diagram of FIG. 1, additional instances of any of the components shown in FIG. 1 may exist. For example, messaging service 131 may be implemented by one or more messaging service servers and message threat detection service 141 may be similarly implemented by one or more message threat detection service servers. Additionally, clients 101, 103, and 105 are example client devices. Although three clients are shown (clients 101, 103, and 105), many more additional clients can exist. Similarly, although only a single messaging service is shown (digital messaging service 131), many more messaging services can be supported and monitored by message threat detection service 141. In some embodiments, components not shown in FIG. 1 may also exist and/or the network configuration of the included components may differ from what is shown.

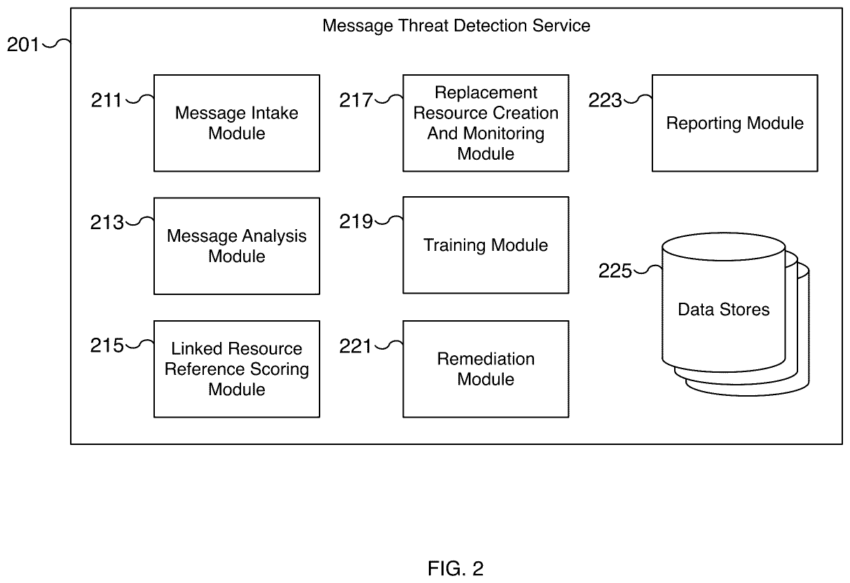

FIG. 2 is a block diagram illustrating an embodiment of a threat detection system for analyzing messages for linked resource references. In the example shown, message threat detection service 201 includes message intake module 211, message analysis module 213, linked resource reference scoring module 215, replacement resource creation and monitoring module 217, training module 219, remediation module 221, reporting module 223, and data stores 225. When configured for detecting threats from linked resource references embedded in messages, message threat detection service 201 analyzes messages and can replace identified malicious or potentially threatening linked resource references with replacement references that redirect to an interstitial resource. Using the created interstitial resource, message threat detection service 201 can monitor the identified linked resource reference for user interactions and based on the tracked user interactions can initiate additional security actions. In some embodiments, message threat detection service 201 is message threat detection service 141 of FIG. 1 and the messages analyzed for threats are serviced by messaging service 131 of FIG. 1.

In some embodiments, message intake module 211 is a processing module for ingesting messages associated with a messaging service for analysis. For example, message intake module 211 can be configured to retrieve messages associated with a user (such as a user associated with an enterprise) to initiate the analysis of the retrieved messages for security threats. In some embodiments, message intake module 211 connects directly (such as via a provided application programming interface) with a messaging service such as messaging service 131 of FIG. 1. In some embodiments, message intake module 211 connects directly with clients of the messaging service such as messaging applications running on clients 101, 103, and/or 105 of FIG. 1. Message intake module 211 can be configured with the proper settings and authorization to retrieve and modify messages. For example, when a retrieved message is identified as having linked resource references that pose a security threat, the references identified as threats can be replaced with replacement linked resource references. In various embodiments, message intake module 211 can be configured to function with multiple different messaging services and platforms and interfaces with one or more of the other processing modules of message threat detection service 201 to perform message threat detection, mitigation, and remediation.

In some embodiments, message analysis module 213 is a processing module for analyzing messages to identify linked resource references. For example, for a message ingested via message intake module 211, such as an email message or another type of message, message analysis module 213 can analyze the message to extract embedded linked resource references. Each detected linked resource reference may correspond to a URL, such as a URL referencing a website including one used to distribute malware, implement phishing operations, harvest user credentials, or initiate other forms of security threats. In some embodiments, the identified linked resource references utilize other protocols such as file transfer protocols or email protocols. In some embodiments, message analysis module 213 can extract each linked resource reference in a message and further identify entity components within an identified linked resource reference, such as a protocol, a domain name, a file path, third-party service (such as a URL shortener), a sender or receiver identity, etc. In some embodiments, message analysis module 213 can further extract other entity values associated with a message such as the subject, header origin internet protocol (IP) address, message text, and attachments.

In some embodiments, linked resource reference scoring module 215 is a processing module for scoring an identified linked resource reference. For example, each identified linked resource reference can be scored by reference scoring module 215 to determine a threat score. The threat score can be evaluated against one or more replacement criterion, which are used to determine whether to replace the identified linked resource reference with a replacement linked resource reference to an interstitial resource. In some embodiments, the replacement linked resource reference and the corresponding interstitial resource are generated via replacement resource creation and monitoring module 217.

In various embodiments, linked resource reference scoring module 215 can determine the threat score for an identified linked resource reference based at least in part on one or more attributes of the specific linked resource reference. Example attributes of a linked resource reference can include the domain name, whether a reference shortener is used, whether authentication is used, and past knowledge of the reference, among other attributes. In some embodiments, message entity values are also used in determining a threat score, such as values with the message subject, header origin IP address, message text, and attachments, among others.

In some embodiments, linked resource reference scoring module 215 can make use of heuristics, rules, neural networks, or other trained ML algorithms that rely on decision trees (e.g., gradient-boosted decision trees), logistic regression, or linear regression. Accordingly, linked resource reference scoring module 215 may produce discrete outputs or continuous outputs, such as a probability metric (e.g., specifying the likelihood that an identified linked resource reference is malicious), a binary output (e.g., malicious or not malicious), or a classification (e.g., specifying the type of malicious linked resource reference).

In some embodiments, linked resource reference scoring module 215 may also consider combinations of digital activities—across the same messaging platform or different messaging platforms—to determine whether a security threat exists. This may be done in a “rolling” manner, where linked resource references identified for a given account are compared against prior identified linked resource references with the given account that have been identified as unusual to some degree or as potential security threats. Moreover, an identified linked resource reference with the given account can be compared against prior identified linked resource references with related accounts (e.g., corresponding to other platforms or users) that have been identified as unusual or as potential security threats.

In some embodiments, replacement resource creation and monitoring module 217 is a processing module for creating replacement resource references and their associated interstitial resources such as an intermediate landing and forwarding webpage for an identified linked resource reference. Replacement resource creation and monitoring module 217 can also function as a processing module for monitoring user interactions with the created interstitial resources. For example, user interactions to and at the interstitial resources can be tracked and the results used to inform message threat detection service 201 on identified threats including past, current, and future threats. In some embodiments, the created interstitial resources are customized for identified linked resource references and include content such as warning messages and details to inform users of the threat associated with an identified linked resource reference. Using the created interstitial resources, replacement resource creation and monitoring module 217 can also track user interaction such as the users and related information on the users who visit each interstitial resource. Based on the monitored results tracked by replacement resource creation and monitoring module 217, remediation actions including security actions can be performed by remediation module 221.

In some embodiments, training module 219 is a processing module for training models for message threat detection and remediation. In some embodiments, training module 219 operates to train the models employed by the other modules such as to train the machine learning (ML) model(s) employed by message analysis module 213, linked resource reference scoring module 215, and/or remediation module 221. For example, if message analysis module 213, linked resource reference scoring module 215, and/or remediation module 221 are designed to apply ML model(s) to the message data obtained from a messaging service (or another data source), training module 219 can train the respective ML model(s) by feeding training data into those ML model(s). The training data could user interaction and related data tracked by replacement resource creation and monitoring module 217. The training data may be employee-or enterprise-specific so that the ML model(s) are able to perform personalized analysis. In some embodiments, the training data ingested by the ML model(s) includes malicious messages and linked resource references that are representative of known instances used for account compromise. For example, these malicious linked resource references may include attributes and/or properties, such as keywords, domain names, and/or the type of authentication and/or protocol used, that are known to represent instances that pose a security threat, such as known instances of fraud or phishing.

Moreover, training module 219 may implement a retraining pipeline (or simply “pipeline”) in order to protect against novel threats including newly identified threats. At a high level, the pipeline may be representative of a series of steps that, when executed by training module 219, cause the models employed by message analysis module 213, linked resource reference scoring module 215, and/or remediation module 221 to be retrained. By consistently training the models using up-to-date information, message threat detection service 201 can protect against novel threats that would otherwise escape detection.

In some embodiments, remediation module 221 is a processing module for performing remediation for a detected security threat associated with an identified linked resource reference. For example, based on tracked user interactions for a particular linked resource reference in a message, remediation module 221 can initiate one or more different security actions. For example, a user that has visited a known malicious reference can have their account suspended and be required to reset their password. As another example, based on tracked user interactions, linked resource references similar to a monitored linked resource reference can be flagged as potentially malicious and related senders of messages with the associated linked resource references can be flagged. In some embodiments, remediation module 221 may utilize reporting module 223 to provide remediation results and/or to receive administration configuration and/or parameters for performed or pending security actions.

In some embodiments, reporting module 223 is a processing module for providing reports on threat detection results including insights on linked resource references identified as security threats. In some embodiments, reporting module 223 provides reports derived from the outputs that are produced by linked resource reference scoring module 215. For example, reporting module 223 may provide a summary of the linked resource references threats discovered from analyzing messages and surface insights into threats in a human-readable format. Other reporting information can be provided as well including details, summaries, and insights on user interactions with identified linked resource references. In some embodiments, reporting module 223 provides an interactive user interface for examining threat results such as an interactive online dashboard.

In some embodiments, data stores 225 are a collection of one or more data stores used by the different modules of message threat detection service 201. For example, data stores 225 can include a remediation configuration data store and be used to store threat detection configurations including replacement criteria and associated thresholds used to analyze determined security scores. In some embodiments, data stores 225 are further used to store data related to customized interstitial resources such as intermediate landing pages, their content, and their interaction data. The interaction data can include the identities of users who have visited the resource, the time and date of the visits, groups to which the visiting user belongs, access permissions assigned to the visiting user, access to the underlying linked resource references, and/or the time and date of access to the underlying linked resource references, among other interaction data. In some embodiments, data stores 225 store account information including the different messaging services and their messaging accounts that have been configured for threat detection. As another example, data stores 225 can be used to store administrative and/or account credentials for interfacing with different messaging service platforms such as credentials and configuration settings required for ingesting messages from a message service. Data stores 225 can be further used to store security metrics, analytics, and reports including detected security threats and corresponding remediation results. Although not shown in FIG. 1, data stores 225 may be implemented with distributed data stores such as one or more distributed data stores accessed.

In some embodiments, one or more of the components of message threat detection service 201 may be implemented individually while operating “alongside” message threat detection service 201. For example, reporting module 223 may be implemented in a remote computing environment to which message threat detection service 201 is communicatively connected across a network. In various embodiments, message threat detection service 201 may be implemented by a security service on behalf of an enterprise or the enterprise itself. In some embodiments, aspects of message threat detection service 201 are accessible or interactable via a web-accessible computer program operating on a computer server or a distributed computing system. For example, an individual may be able to interface with message threat detection service 201 through a web browser that is executing on an electronic computing device (also called an “electronic device” or “computing device”).

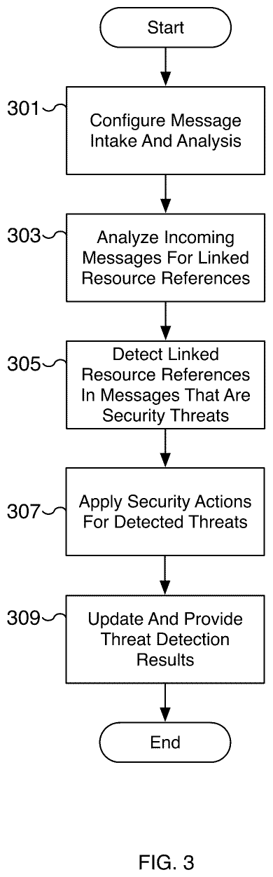

FIG. 3 is a flow chart illustrating an embodiment of a process for performing threat detection by analyzing messages for linked resource references. For example, using the process of FIG. 3, a message threat detection service can detect potential threats posed by messages embedded within malicious linked resource references. Security actions can be performed for linked resource references identified as security threats. For example, malicious linked resource references can be replaced with a replacement linked resource reference that forwards to an interstitial resource. In various embodiments, as part of the performed security action, user interactions with identified malicious linked resource references are monitored and tracked. Results from the threat detection can be made available, for example, as reports or via an interactive dashboard. In some embodiments, the detection results are used to continually improve the threat detection process. In some embodiments, the process of FIG. 3 is performed by a message threat detection service such as message threat detection service 141 of FIG. 1 and/or message threat detection service 201 of FIG. 2. In some embodiments, the messages analyzed for threats are hosted by a messaging service such as messaging service 131 of FIG. 1.

At 301, message intake and analysis are configured. For example, the ability to ingest messages associated with a messaging service is configured. The provided configuration may include user credentials and/or configuration settings for an application programming interface to access desired messaging services. In some embodiments, multiple different messaging services are configured allowing the message threat detection service to monitor messages from different messaging platforms. In some embodiments, the configuration includes configuring access to a messaging service and/or access to user message stores such as user message inboxes and folders. In addition to configuring message intake, message analysis can be configured. For example, different parameters such as threat thresholds and/or replacement criteria can be configured for use when a message is analyzed. For example, for certain users, such as new users, a lower threshold may be utilized to trigger security actions, whereas for experienced users, a higher threshold may be more appropriate.

At 303, incoming messages are analyzed for linked resource references. For example, messages associated with a messaging service are ingested and analyzed for embedded linked resource references. Each of the identified linked resource references may correspond to a URL, such as a URL referencing a website including ones used to distribute malware, implement phishing operations, harvest user credentials, or initiate other forms of security threats. In some embodiments, the identified linked resource references utilize other protocols such as file transfer protocols or email protocols. The analysis performed for linked resource references can include identifying entity components within an identified linked resource reference, such as a protocol, a domain name, a file path, third-party service (such as a URL shortener), a sender or receiver identity, etc. Other entity values may also be extracted as part of the analysis including values associated with the associated message such as the subject, header origin internet protocol (IP) address, message text, and attachments.

At 305, linked resource references in messages that are security threats are detected. For example, once a linked resource reference in a message is identified, a determination is made whether the reference is a potential security threat. In various embodiments, each identified linked resource reference is individually scored. Based on the assessed threat score, a linked resource reference may be replaced with a replacement linked resource reference to an interstitial resource. In various embodiments, the scoring process can include evaluating attributes of a linked resource reference including individual components of a linked resource reference such as the protocol, domain name, keywords, whether a reference shortener is used, whether authentication is used, the type of authentication used, and past knowledge of the reference, among other attributes. In some embodiments, the scoring further utilizes additional context such as attributes of the associated message including attributes associated with the message subject, header, IP addresses, message text, and attachments.

At 307, security actions are applied for detected threats. For example, one or more security actions are applied to minimize and/or mitigate the detected threats and/or to prevent future related threats. The security actions can include the creation and hosting of an interstitial resource such as an intermediate landing page that allows a user to access the original reference but with the appropriate warnings and guidance. The applied security actions can further include advanced monitoring and tracking of user interactions including access to the original reference and related references or resources. In some embodiments, security actions such as disabling an account, requiring new account credentials, requiring a password reset, and/or notifying security personnel, among other actions are performed.

At 309, threat detection results are updated and provided. For example, the results from performing threat detection including detected linked resource references, the associated messages, senders, and receivers, and access to the detected references can be provided. The results can be provided via reports such as routine or on-demand email reports, via notifications, and/or via an online dashboard such as an interactive threat assessment and management dashboard, among other approaches. For example, an email report may include a summary of the linked resource reference threats discovered from analyzing messages and surface insights into threats in a human-readable format. Other reporting information can be provided as well including details, summaries, and insights on user interactions with identified linked resource references.

In some embodiments, as part of updating the threat detection results, the threat detection process is also updated and improved. For example, the updated threat detection results can be utilized for training data for improving models used for identifying, scoring, and remediating security threats. The updated threat detection results can also be used to customize responses for users or groups, for example, based on their monitored behavior. For example, threat assessment criteria and thresholds can be adjusted and/or modified as part of updating the threat detection results.

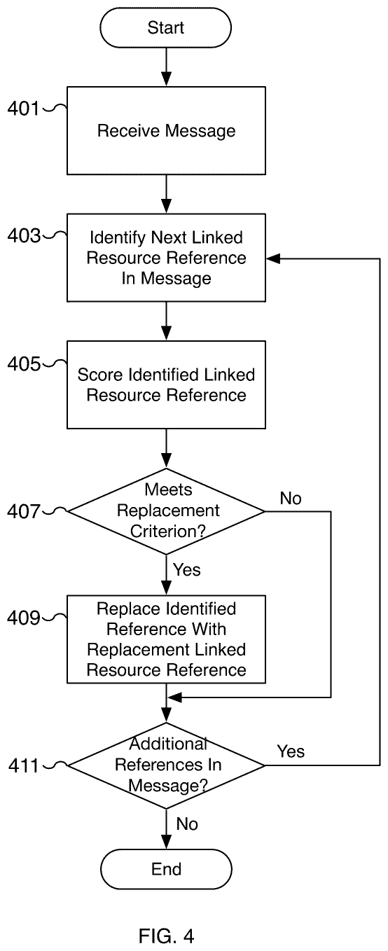

FIG. 4 is a flow chart illustrating an embodiment of a process for analyzing linked resource references embedded within messages for security threats. For example, using the process of FIG. 4, a received message is analyzed to identify all embedded linked resource references, which are then each analyzed to determine which ones are security threats. When an identified linked resource reference is found to be a potential security threat, the reference can be replaced with a replacement linked resource reference that forwards to an interstitial resource. In various embodiments, each linked resource reference in a message is individually scored and a custom replacement reference with a corresponding interstitial resource can be created for each one found to be a security threat. In some embodiments, the process of FIG. 4 is performed at 303, 305, and/or 307 of FIG. 3 by a message threat detection service such as message threat detection service 141 of FIG. 1 and/or message threat detection service 201 of FIG. 2. In some embodiments, the messages analyzed for threats are hosted by a messaging service such as messaging service 131 of FIG. 1.

At 401, a message is received. For example, an incoming (or outgoing) message is received for a user with threat detection monitoring enabled. The message can be received directly from the user client, such as via the user's messaging application and/or via the messaging service or platform. Depending on the messaging service and its available integration features, the format and technique for ingesting the message may differ. In various embodiments, the received message includes the entire message and may include metadata for the message such as message headers, IP addresses, and sender and receiver information, among other data. In some embodiments, the received message includes additional context such as the user account and related groups to which the user belongs, access permissions assigned to the user, user configuration settings, past user behavior and interactions, and/or behavior and interactions of related users such as other users belonging to the same groups or enterprises and/or from the same regions or locations. The context data received can also include data from related messages or messaging systems, such as user data for the same user but from another messaging system. Other data including message and user metadata may also be received.

At 403, the next linked resource reference in the message is identified. For example, a message may include many linked resource references, and the next linked resource reference among the set of references is identified. In various embodiments, a linked resource reference is identified by analyzing the body of the message for the particular linked resource reference format. In some embodiments, the identification of the next linked resource reference is performed by applying syntax analysis to the message, such as by utilizing syntactic rules specific to linked resource references. Other extraction approaches can be appropriate as well, such as applying one or more ML models, applying natural language processing, applying semantic and/or contextual analysis, and/or another resource extraction approach.

At 405, the identified linked resource reference is scored. For example, the linked resource reference identified at 403 is independently scored to determine a threat score. The assigned threat score can be unique to the identified linked resource reference and other linked resource references identified within the same message can and likely will have different threat scores. In various embodiments, the threat score is determined based on the identified linked resource reference and its attributes. For example, the scoring process can include evaluating attributes of a linked resource reference including individual components of a linked resource reference such as the protocol, domain name, keywords, whether a reference shortener is used, whether authentication is used, the type of authentication used, and past knowledge of the reference, among other attributes. In some embodiments, the scoring further utilizes additional context such as attributes of the associated message including attributes from metadata for the user and/or message received at 401. Additional context attributes can include the message subject, message header values, IP addresses, message text, and attachments, among others.

At 407, a determination is made whether the scored linked resource reference meets a replacement criterion. For example, the threat score determined at 405 for the identified linked resource reference is evaluated against one or more replacement criteria such as a replacement score threshold. In the event the scored linked resource reference meets a replacement criterion, processing proceeds to 409. In the event the scored linked resource reference does not meet a replacement criterion, processing proceeds to 411.

At 409, the identified linked resource reference is replaced with a replacement linked resource reference. For example, a replacement linked resource reference is created and used to replace the linked resource reference identified at 403, scored at 405, and found to meet a replacement criterion at 407. The created replacement linked resource reference includes a reference to an interstitial resource and replacing the identified reference with a replacement linked resource reference prevents direct access to the identified linked resource reference. In some embodiments and although not strictly required, the created replacement linked resource reference and corresponding interstitial resource can be unique to the identified linked resource reference, and each identified linked resource reference with a replacement reference can utilize a different replacement linked resource reference and corresponding interstitial resource.

At 411, a determination is made whether there are additional linked resource references in the message. For example, processing on the message received at 401 may not be complete and the message may contain additional embedded linked resource references that require analysis. In the event there are additional linked resource references in the message, processing loops back to 403 where the next linked resource references in the message can be analyzed. In the event there are no additional linked resource references in the message, processing completes. In various embodiments, the process of FIG. 4 is then performed on another message.

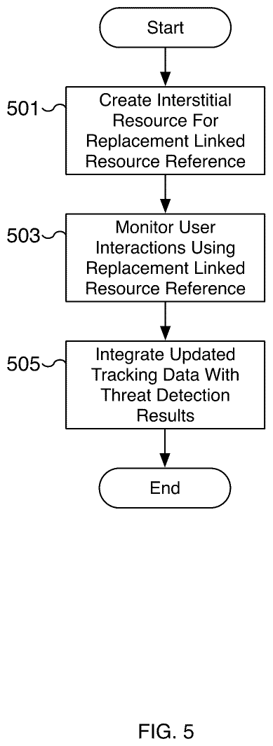

FIG. 5 is a flow chart illustrating an embodiment of a process for responding to a linked resource reference identified as a security threat. For example, using the process of FIG. 5, a linked resource reference identified as a security threat is replaced with a replacement linked resource reference that forwards to an interstitial resource. The replacement linked resource reference and corresponding interstitial resource are used to manage the identified security threat including to monitor user interactions with the security threat. Results from the monitoring including tracking results are integrated with the threat detection results. In some embodiments, the process of FIG. 5 is performed at 307 and/or 309 of FIG. 3 by a message threat detection service such as message threat detection service 141 of FIG. 1 and/or message threat detection service 201 of FIG. 2. In some embodiments, the linked resource reference is embedded in a message hosted by a messaging service such as messaging service 131 of FIG. 1.

At 501, an interstitial resource is created for a replacement linked resource reference. For example, an interstitial resource such as a customized landing webpage is created for use with a replacement linked resource reference. The linked resource of the replacement linked resource reference corresponds to the interstitial resource. Users that click on the replacement linked resource reference can be forwarded to the interstitial resource. As part of creating the interstitial resource, the content for the interstitial resource is generated. The generated content can include warnings and guidance on the security threat associated with the original linked resource reference that has been replaced. In some embodiments, the content includes appropriate warnings and details of the replaced linked resource reference while also allowing the user to proceed with the appropriate knowledge to the original linked resource reference. In various embodiments, the created interstitial resource can embed monitoring and tracking functionality that allows the threat detection system to monitor user interactions, including behavior and intent, with the original linked resource reference. For example, the created interstitial resource can include functionality to track each visit to the interstitial resource including the source location and user profile of the visiting user. Additionally, in the event the user intends to proceed with visiting the original linked resource from the interstitial resource, the created interstitial resource can include functionality to track and profile the visit to the original linked resource.

At 503, user interactions are monitored using the replacement linked resource reference. For example, using the replacement linked resource reference and the corresponding interstitial resource created at 501, interactions with the original and replaced linked resource reference are monitored. In some embodiments, the user interactions are monitored by the functionality embedded in the created interstitial resource and/or the services utilized for hosting the interstitial resource. The monitored user interactions can include collecting tracking data on the user (or users) who have visited the resource, the identity of a visiting user, a time of a visit to the interstitial resource by a visiting user, a source associated with a visiting user such as a user's location and/or IP address, the time spent on the interstitial resource by a visiting user, the content from the interstitial resource that was reviewed by a visiting user such as the provided warnings, details, and/or guidelines on potential security threats, the frequency and count of user visits, access or access attempts by a visiting user to the underlying linked resource reference from the interstitial resource, and/or the time and date of access to the underlying linked resource reference from the interstitial resource by a visiting user, among other user related interactions. In some embodiments, each interstitial resource can be unique for an identified linked resource reference and its corresponding replacement linked resource reference. In some scenarios, the replacement linked resource reference and/or the interstitial resource may be shared, for example, for common references, similar security threats, and/or similar user groups, among other purposes.

At 505, updated tracking data is integrated with threat detection results. For example, the data tracked at 503 is integrated with other threat detection results. By augmenting the threat detection results with tracking data including monitored user interactions, the process for detecting security threats can be continuously improved including by detecting new or novel threats. In various embodiments, the integrated data allows for refinement of security thresholds including for the refinement and configuration of replacement criteria used to replace an identified linked resource references with replacement linked resource references to created interstitial resources.

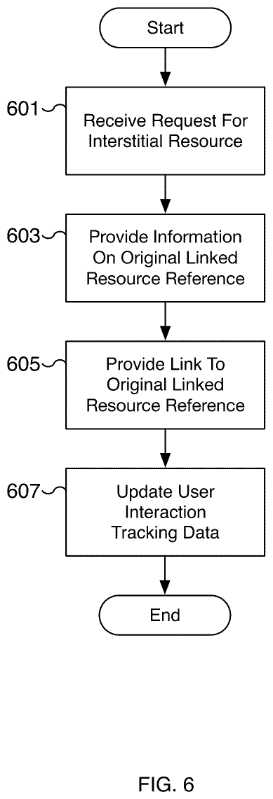

FIG. 6 is a flow chart illustrating an embodiment of a process for employing an interstitial resource as a response to a linked resource reference identified as a security threat. For example, using the process of FIG. 6, a linked resource reference identified as a security threat is replaced with a replacement linked resource reference that forwards to an interstitial resource. When accessed, the interstitial resource can provide a visiting user with the appropriate warnings and details of the replaced original linked resource reference, such as why the original linked resource reference was deemed a security threat, while also allowing the user to proceed with the appropriate knowledge to the original linked resource reference. The interstitial resource can also be used to track and monitor user interactions to the original linked resource reference. For example, requests to the interstitial resource are used to manage the identified security threat including to monitor user interactions with the security threat. The tracked results can be integrated with overall threat detection results. In some embodiments, the process of FIG. 6 is performed at 307 and/or 309 of FIG. 3 and/or at 503 and/or 505 of FIG. 5 by a message threat detection service such as message threat detection service 141 of FIG. 1 and/or message threat detection service 201 of FIG. 2. In some embodiments, the interstitial resource is created for messages hosted by a messaging service such as messaging service 131 of FIG. 1.

At 601, a request for an interstitial resource is received. For example, a user clicks on a replacement linked resource reference that directs the user to the interstitial resource. In various embodiments, the replacement linked resource reference replaces a linked resource reference in a message when the linked resource message has been identified as a security threat. The replacement reference allows the threat detection system to intervene when a user interacts with a potentially malicious linked resource reference. In response to directing the user to the interstitial resource, a request for the interstitial resource and its content are received. For example, the interstitial resource may be a webpage hosted by and/or on behalf of the threat detection system.

At 603, information on the original linked resource reference is provided. For example, in response to receiving a request at 601 for the interstitial resource, the contents of the interstitial resource are provided to the visiting user. The contents can be provided in the form of a webpage or similar user dialog or user interface. In various embodiments, the interstitial resource is an intermediate or landing website and the content provided by the interstitial resource includes information on the original linked resource reference embedded with a message. The provided information can include a description of an identified security threat associated with the linked resource reference and/or a description of one or more security threat characteristics associated with the linked resource reference. For example, the provided information includes the appropriate warnings and details of the replaced linked resource reference including an explanation on why the linked resource reference was identified as a potential security threat and the best practices when treating a threat of this type.

At 605, a link to the original linked resource reference is provided. In addition to providing information at 603 on the security threat associated with the original linked resource reference, the information provided on the original linked resource reference includes a reference to the linked resource reference accessible from the interstitial resource. For example, the interstitial resource provides a method for the visiting user to visit the original linked resource reference. In this manner, the interstitial resource functions as an information-providing intermediate resource or proxy without completely blocking access to the original linked resource reference. In some embodiments, the link to the original linked resource reference is a tracked reference link that allows user access to the original linked resource reference to be tracked including by the number of times, frequency, estimated duration of visit, requesting location, and/or requesting user, among other related data. In some scenarios, access to the original linked resource reference from the interstitial resource may be blocked and/or at least require administrative approval and/or additional user verification to proceed with visiting the original linked resource reference. In some embodiments, access to the original linked resource reference is blocked unless accessed via an interstitial resource. For example, the threat detection system can block all direct access to the original linked resource reference and access to the original linked resource reference is only allowed if the access is directed by an interstitial resource.

At 607, user interaction tracking data is updated. For example, based on the data collected by and with the interstitial resource, user interaction tracking data and threat detection results are updated. For example, tracking data on user interactions with potential security threats is updated and can be used to inform security personnel and/or to implement additional security actions. In some embodiments, the tracking data is compared with configured and/or dynamic thresholds that can be used to increase security measures and protection when they are exceeded. For example, a sudden surge in visits to a site referenced by a linked resource reference can trigger additional security actions. In various embodiments, the tracking data is used to continuously improve threat detection results including to improve and refine identification and replacement criteria for linked resource references in messages.

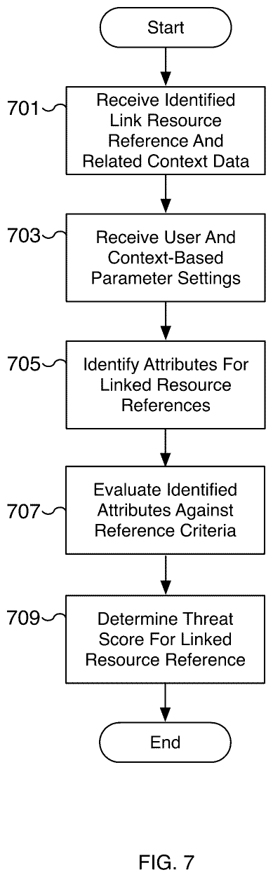

FIG. 7 is a flow chart illustrating an embodiment of a process for scoring a linked resource reference identified in a message. For example, using the process of FIG. 7, an identified linked resource reference is assessed a threat score. The threat score can be used to determine whether the specific linked resource reference is a security threat. In some embodiments, the process of FIG. 7 is performed 303, 305, and/or 307 of FIG. 3 and/or at 405 of FIG. 4 by a message threat detection service such as message threat detection service 141 of FIG. 1 and/or message threat detection service 201 of FIG. 2. In some embodiments, the scored linked resource reference is embedded in a message hosted by a messaging service such as messaging service 131 of FIG. 1.

At 701, an identified link resource reference and related context data are received. For example, a link resource reference extracted from a message is received along with metadata related to the link resource reference and associated message. The related metadata can include information based on the message such as data and/or metadata based on the message subject, the message headers, IP addresses associated with the message, the message text, and attachments included with the message. In various embodiments, the data received at 701 can be modified, augmented, and/or configured as appropriate including based on newly identified attributes that are helpful in identifying security threats.

At 703, user and context-based parameter settings are received. For example, parameter settings for a user and/or relevant for the context of the user, the message, and the identified link resource reference are received. In some embodiments, threat scores can be based on the user and/or configured differently for different users or groups of users. For example, novice users, new users, and/or new accounts may be configured with lower threshold values than accounts associated with experienced or trained users. Similarly, users previously lured by phishing attacks may have lower thresholds and/or have their thresholds reset. In some embodiments, the data received at 703 is used to determine reference criteria and can be used for evaluating against attributes of the identified link resource reference. The included context-based parameter settings may include current counts and frequency metrics such as how often a domain name has been seen or how often experienced users have clicked on a related link resource reference.

At 705, attributes for linked resource reference are identified. For example, attributes used for scoring a linked resource reference are identified from the data received at 701 and/or 703. The attributes can be overlapping in nature and may utilize both information on the linked resource reference as well as the message and its metadata. Example attributes based on the linked resource reference can include attributes based on the protocol used, the domain name, keywords found within the linked resource reference, whether a reference shortener is used, whether authentication is used, the type of authentication used, past knowledge of the reference including whether the linked resource reference has been seen before, and whether the linked resource reference uses (or does not use) known words such as words found in a dictionary, among other attributes. Additional attributes can be identified as related to the message including attributes associated with the message subject, header, IP addresses, message text, and attachments.

At 707, the identified attributes are evaluated against reference criteria. For example, the attributes identified at 705 are evaluated against one or more reference criteria to determine scores for the attributes or for sets of attributes. In some embodiments, reference criteria such as running heuristics including those based on parameters received at 703 are used to evaluate against the identified attributes. The attributes can be evaluated alone or in groups or sets. For example, two or more attributes can be evaluated using Boolean logic operations (e.g., ANDed and/or ORed together) and compared against reference criteria. The applied logical operations can include logical conjunction (AND), logical disjunction (OR), logical negation (NOT), exclusive OR (XOR), not AND (NAND), not OR (NOR), and/or exclusive NOR (XOR). As one example, the attributes associated with (1) whether authentication is used, (2) whether the domain name has been seen before, and (3) whether a reference shortener is not used can be ANDed together and compared against a reference value.

In some embodiments, the evaluated results include both a risk score and an abnormality score. In some embodiments, a risk score can be associated with how often the evaluated result occurs in attacks or security threats, and an abnormality score can describe how unusual a given result is. Additional evaluation scores can be utilized as well, as appropriate. For example, in some embodiments, count and frequency scores are evaluated for attributes. The counts and frequency scores can be updated based on past analysis results.

At 709, a threat score is determined for the linked resource reference. For example, based on the evaluations performed at 707, the evaluation results are integrated to determine a threat score for the linked resource reference. Since the evaluations are at least partially dependent on the individual and specific nature of the linked resource reference, the determined threat score is unique to the linked resource reference even when compared against other linked resource references found in the same message. In some embodiments, the different evaluation results are aggregated together using configured and/or determined weights. For example, an aggregation weight can be applied to each evaluated attribute or set of attributes to determine a single threat score for the linked resource reference. In some embodiments, two or more threat scores may be determined and/or the determined threat score may have multiple components. For example, a threat score may include a risk score and an abnormality score component similar to the risk and abnormality scores determined at 707 for attributes and/or sets of attributes.

In some embodiments, once a threat score is determined, the assessed threat score can be used to calibrate parameters and/or reference criteria for evaluating and scoring linked resource references such as linked resource references to be identified and scored in the future. For example, applied parameters and reference criteria may require calibration and/or may be normalized over time as new forms of attacks are identified. Similarly, counts and frequency metrics may be updated and a threshold adjusted. In some embodiments, the process for determining threat scores is dynamic and threat scores calculated at different times within different contexts for the same linked resource reference and message can be different.

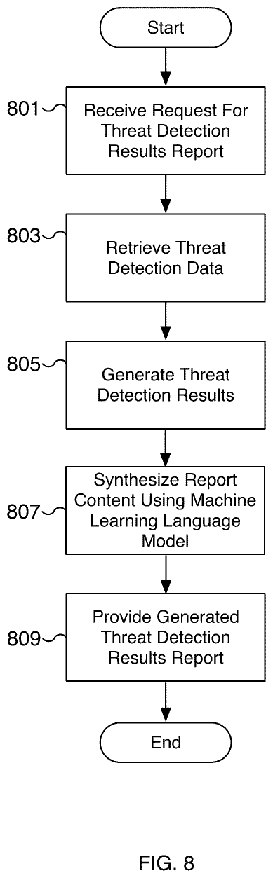

FIG. 8 is a flow chart illustrating an embodiment of a process for automatically generating a threat detection report. For example, using the process of FIG. 8, threat detection results from monitoring a linked resource reference and related threat detection results can be generated. The results can be provided as a report such an email report, accessed interactively such as via a dashboard, or via another medium such as via notifications. In some embodiments, the process of FIG. 8 is performed at 309 of FIG. 3, at 505 of FIG. 5, at 607 of FIG. 6, and/or at 709 of FIG. 7 by a message threat detection service such as message threat detection service 141 of FIG. 1 and/or message threat detection service 201 of FIG. 2. In some embodiments, the provided threat detection report corresponds to analyzed messages hosted by a messaging service such as messaging service 131 of FIG. 1.

At 801, a request for a threat detection report is received. For example, a request for a threat detection report based on analyzing messages for monitored users is received. The request can be initiated by a user, scheduled such as a routine report, triggered based on an incident such as a detected security threat, and/or triggered based on a configured event, among other initiation events. In some embodiments, the request includes parameters for generating the report content, such as the scope and depth of the requested content, the intended audience for the report, and/or the user requesting the report, among other parameter values.

At 803, threat detection data is retrieved. For example, tracked and monitored threat detection data including tracked user interaction data is retrieved. In some embodiments, the retrieved data includes user interactions with linked resource references that have been replaced with replacement linked resource references. The retrieved data can include data collected by monitoring the interstitial resources referenced by the replacement linked resource references. Other data for users and the context of user interactions can be retrieved as well.

At 805, threat detection results are generated. For example, results in a human-readable format are generated based on the threat detection data retrieved at 803. The results can be presented and/or formatted based on the request parameters received at 801. In some embodiments, the report is an interactive report and new views of the report can be generated in response to user provided input. For example, a security officer may request to dive into details of the threat detection data, request to zoom out for a more high level view of the threat detection data, or request to view the data using different categories or perspectives.

At 807, report content is synthesized using a machine learning language model. For example, additional report content for the threat detection report, such as insights into the threat detection results and/or different views or summaries of the threat detection results, can be synthesized using one or more large language models (LLMs). The LLMs, which may be accessed via an LLM service, can be utilized to generate additional report content for portions of the threat detection report. The context provided for the LLMs can include portions of the threat detection data retrieved at 803 and/or portions of the initial threat detection results generated at 805. The context may further include any applicable reference reports including previously generated reports and/or report request parameters received at 801 along with the report request. In some embodiments, the report content is generated in response to a generative AI prompt and the prompt is constructed to enforce requirements for the generated report.

At 809, the generated threat detection results report is provided. For example, the generated report on content threat detection results is provided in response to the request received at 801. In some embodiments, the generated report is provided asynchronously, such as via an email or another messaging service. The report may also be provided interactively such as via an online and interactive dashboard. In various embodiments, the report is archived, and a version of the generated threat detection results report is stored and can be referenced in the future including for use in future report generation.

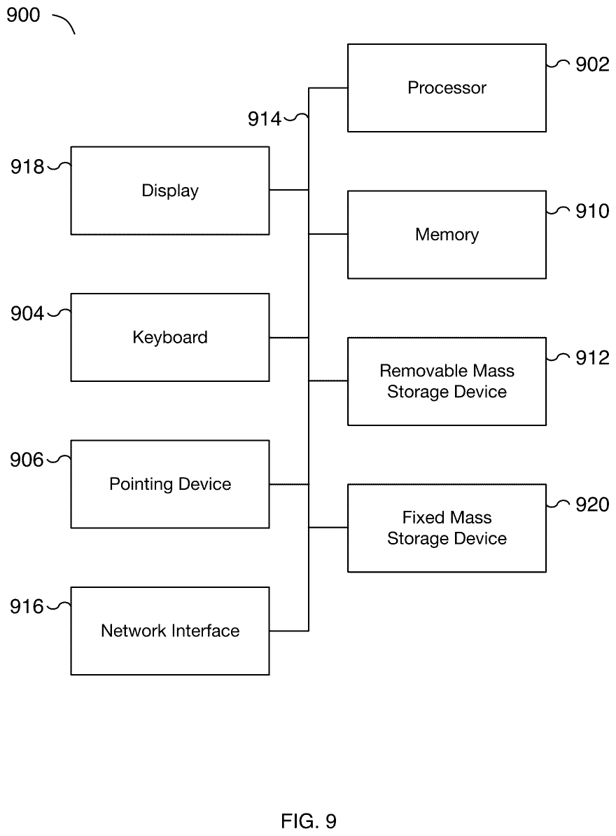

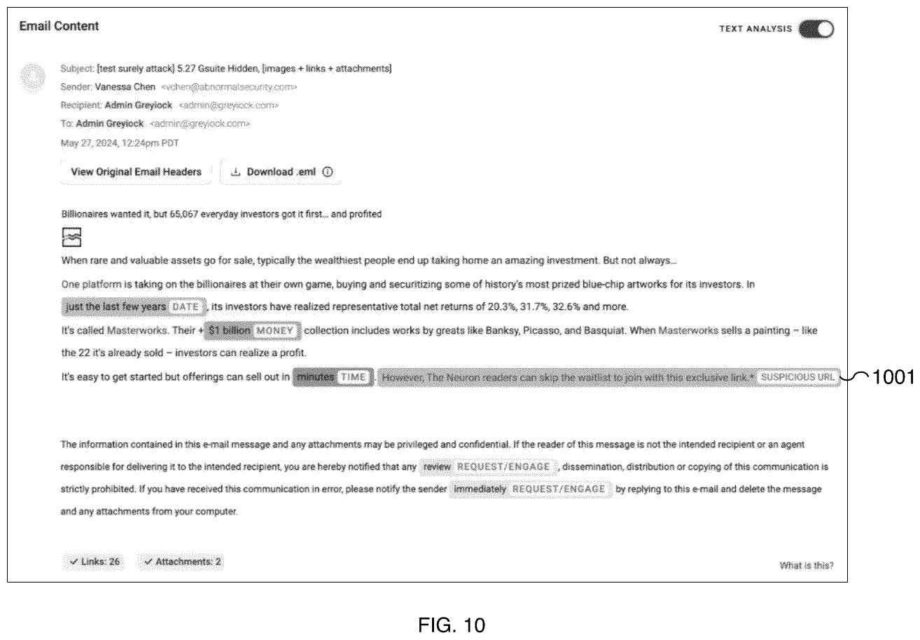

FIG. 9 is a functional diagram illustrating a programmed computer system for detecting and mitigating security threats related to linked resource references in messages. As will be apparent, other computer system architectures and configurations can be utilized for the detection and mitigation of security threats with respect to linked resource references in messages. Examples of computer system 900 include clients 101, 103, and 105 of FIG. 1 and/or one or more computers of messaging service 131 of FIG. 1, message threat detection service 141 of FIG. 1, and/or message threat detection service 201 of FIG. 2. Computer system 900, which includes various subsystems as described below, includes at least one microprocessor subsystem (also referred to as a processor or a central processing unit (CPU)) 902. For example, processor 902 can be implemented by a single-chip processor or by multiple processors. In some embodiments, processor 902 is a general purpose digital processor that controls the operation of the computer system 900. Using instructions retrieved from memory 910, the processor 902 controls the reception and manipulation of input data, and the output and display of data on output devices (e.g., display 918). In various embodiments, one or more instances of computer system 900 can be used to implement at least portions of the processes of FIGS. 3-8 and the functionality associated with the diagrams of FIGS. 10-14.

Processor 902 is coupled bi-directionally with memory 910, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 902. Also as is well known in the art, primary storage typically includes basic operating instructions, program code, data and objects used by the processor 902 to perform its functions (e.g., programmed instructions). For example, memory 910 can include any suitable computer-readable storage media, described below, depending on whether, for example, data access needs to be bi-directional or unidirectional. For example, processor 902 can also directly and very rapidly retrieve and store frequently needed data in a cache memory (not shown).

A removable mass storage device 912 provides additional data storage capacity for the computer system 900, and is coupled either bi-directionally (read/write) or unidirectionally (read only) to processor 902. For example, storage 912 can also include computer-readable media such as magnetic tape, flash memory, PC-CARDS, portable mass storage devices, holographic storage devices, and other storage devices. A fixed mass storage 920 can also, for example, provide additional data storage capacity. The most common example of mass storage 920 is a hard disk drive. Mass storages 912, 920 generally store additional programming instructions, data, and the like that typically are not in active use by the processor 902. It will be appreciated that the information retained within mass storages 912 and 920 can be incorporated, if needed, in standard fashion as part of memory 910 (e.g., RAM) as virtual memory.

In addition to providing processor 902 access to storage subsystems, bus 914 can also be used to provide access to other subsystems and devices. As shown, these can include a display monitor 918, a network interface 916, a keyboard 904, and a pointing device 906, as well as an auxiliary input/output device interface, a sound card, speakers, and other subsystems as needed. For example, the pointing device 906 can be a mouse, stylus, track ball, or tablet, and is useful for interacting with a graphical user interface.

The network interface 916 allows processor 902 to be coupled to another computer, computer network, or telecommunications network using a network connection as shown. For example, through the network interface 916, the processor 902 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 902 can be used to connect the computer system 900 to an external network and transfer data according to standard protocols. For example, various process embodiments disclosed herein can be executed on processor 902, or can be performed across a network such as the Internet, intranet networks, or local area networks, in conjunction with a remote processor that shares a portion of the processing. Additional mass storage devices (not shown) can also be connected to processor 902 through network interface 916.

An auxiliary I/O device interface (not shown) can be used in conjunction with computer system 900. The auxiliary I/O device interface can include general and customized interfaces that allow the processor 902 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 9 is but an example of a computer system suitable for use with the various embodiments disclosed herein. Other computer systems suitable for such use can include additional or fewer subsystems. In addition, bus 914 is illustrative of any interconnection scheme serving to link the subsystems. Other computer architectures having different configurations of subsystems can also be utilized.

FIG. 10 is an example of a user interface view for displaying a message with a replacement linked resource reference. The user interface view of FIG. 10 shows an example message that has been analyzed for malicious linked resource references. The message shown includes replacement linked resource reference 1001 which corresponds to a URL that has been identified as a security threat and has been replaced. In the example shown, the text associated with the identified suspicious URL is highlighted and the label “SUPICIOUS URL” has been added to inform the user of an identified security threat. In various embodiments, replacement linked resource reference 1001 forwards the user to an interstitial resource used to mitigate the identified threat. In some embodiments, the linked resource reference is identified and replaced with a replacement linked resource reference without the additional label and/or highlighting of the message text. In some embodiments, the results shown in the user interface view of FIG. 10 correspond to the analysis and linked resource reference replacement performed by a message threat detection service such as message threat detection service 141 of FIG. 1 and/or message threat detection service 201 of FIG. 2 using one or more of the processes described with respect to FIGS. 3-8. In some embodiments, the message shown is hosted by a messaging service such as messaging service 131 of FIG. 1.

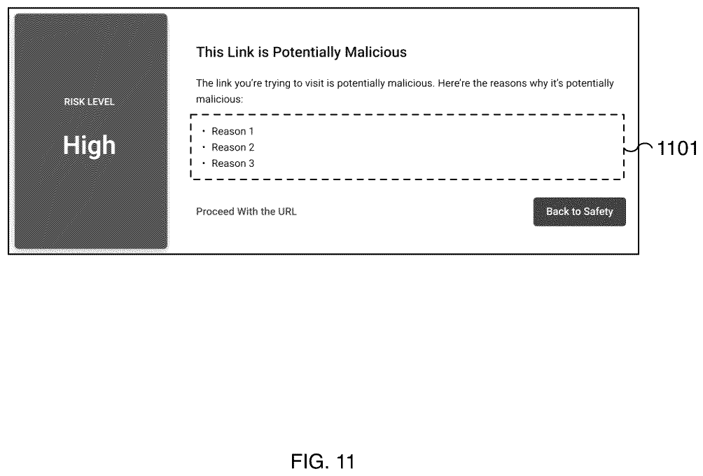

FIG. 11 is an example of a user interface view for displaying an interstitial resource accessed via a replacement linked resource reference. The user interface view of FIG. 11 shows an example user interview view of an embodiment of an interstitial resource for a linked resource reference that has been identified as a security threat. Instead of allowing a user to directly access the linked resource from a message, the user is forwarded by a replacement linked resource reference in the message to the interstitial resource shown in FIG. 11. In some embodiments, the results shown in the user interface view of FIG. 11 correspond to threat detection steps performed by a message threat detection service such as message threat detection service 141 of FIG. 1 and/or message threat detection service 201 of FIG. 2 using one or more of the processes described with respect to FIGS. 3-8. In some embodiments, the interstitial resource is for a linked resource reference from a message hosted by a messaging service such as messaging service 131 of FIG. 1.

In various embodiments, an interstitial resource provides content to inform the visiting user of the potential threat posed by the original linked resource reference. For example, the interstitial resource can provide the user with the security warnings and detailed guidance related to the original linked resource reference. As shown in FIG. 11, the user interface view of FIG. 11 can include a warning risk level (e.g., High) and a message describing that the link is potentially malicious. The user interface view may also include content region 1101, which allows for displaying customized content related to the identified malicious link. Here, the warning content is shown with three placeholder reasons although fewer or more can be appropriate. In various embodiments, content region 1101 is optional and may be customized for each specific identified linked resource reference. Also shown in the user interface view of FIG. 11 is a link titled “Proceed With the URL” that allows the user to proceed with visiting the original linked reference and a button labeled “Back to Safety” that allows the user to return to the original message. In some embodiments, the button labeled “Back to Safety” is an optional user interface button.

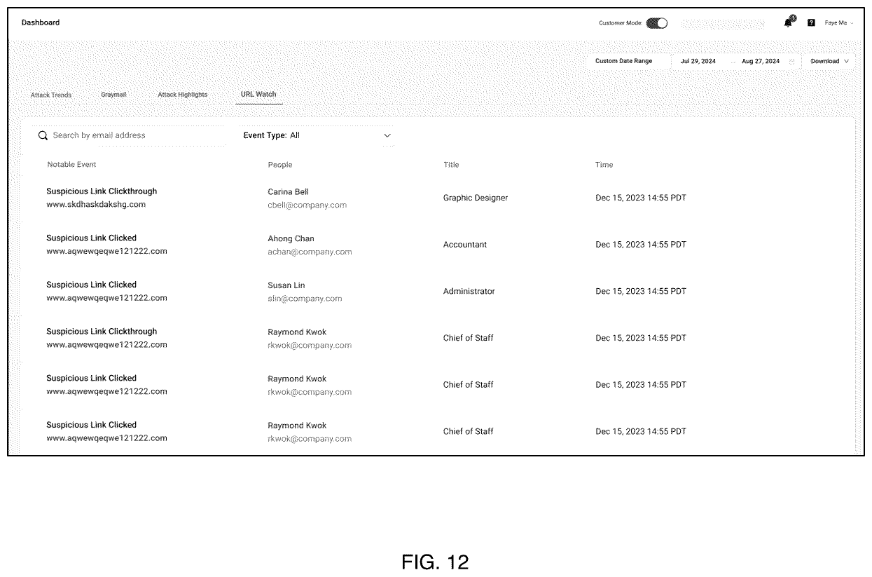

FIG. 12 is an example of a user interface view for displaying threat detection result reports from analyzing a message for malicious linked resource references. The user interface view of FIG. 12 shows example threat detection results from analyzing messages for malicious linked resource references and mitigating the potential security threats from identified threats. In various embodiments, the user interface is an interactive dashboard accessible via a client application such as a web browser. Typically, the user interface is accessed by security personnel to monitor the security of monitored messages and message services. In some embodiments, the results shown in the user interface view of FIG. 12 correspond to threat detection steps performed by a message threat detection service such as message threat detection service 141 of FIG. 1 and/or message threat detection service 201 of FIG. 2 using one or more of the processes described with respect to FIGS. 3-8. In some embodiments, the threat detection results are for messages hosted by a messaging service such as messaging service 131 of FIG. 1.

As shown in the user interface view of FIG. 12, a URL Watch dashboard provides a table view to monitor user interactions with suspicious URLs across an organization. For example, the displayed table highlights users who have clicked on replacement linked resource references and were redirected to a corresponding interstitial resource warning page and/or who proceeded to the original identified linked resource references replaced by the replacement linked resource references. The displayed URL Watch dashboard implements functionality to help security administrators identify and analyze risky behavior and enables necessary follow-up security actions, including password resets or additional training, to enhance security measures. In some embodiments, the displayed user interface view includes a search and filter capability for interfacing with suspicious URL interactions. For example, a security team can utilize the search and filter capability to analyze click patterns and/or behavior for specific users, including identified VIPs and/or higher-risk users. The search and filter capability can aid in implementing targeted security measures.

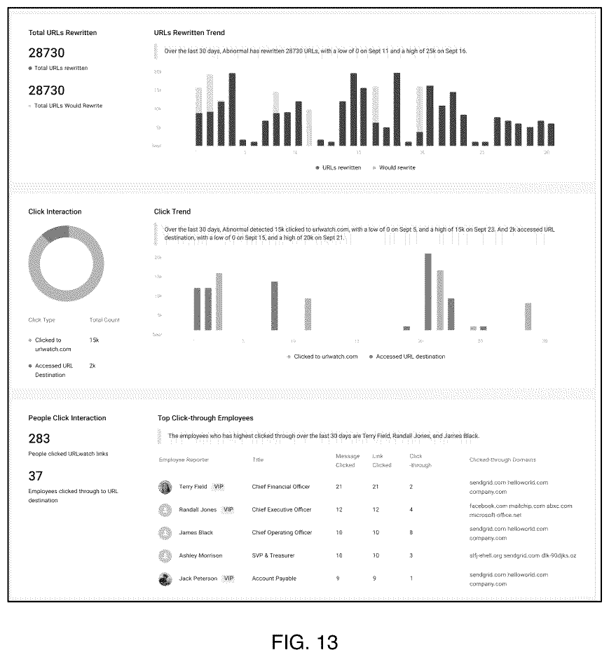

FIG. 13 is an example of a user interface view for displaying threat detection result reports from analyzing a message for malicious linked resource references. The user interface view of FIG. 13 shows example threat detection results from analyzing messages for malicious linked resource references and mitigating the potential security threats from identified threats. In various embodiments, the user interface is an interactive dashboard accessible via a client application such as a web browser. Typically, the user interface is accessed by security personnel to monitor the security of monitored messages and message services. In some embodiments, the results shown in the user interface view of FIG. 13 correspond to threat detection steps performed by a message threat detection service such as message threat detection service 141 of FIG. 1 and/or message threat detection service 201 of FIG. 2 using one or more of the processes described with respect to FIGS. 3-8. In some embodiments, the threat detection results are for messages hosted by a messaging service such as messaging service 131 of FIG. 1.

As shown in the user interface view of FIG. 13, various dialogs are included to provide different metrics and analysis results related to threat detection, mitigation, and remediation, among other security actions. For example, in the top dialog view, the number of linked resource references (referenced as URLs) that have been replaced is shown along with a timeline of when the identified references have been rewritten. In the middle dialog view, tracked user interaction data is displayed. For example, click interaction data including data collected from corresponding interstitial resources used to intercept user clicks to the original linked resource references are shown. A timeline shows both when an interstitial resource is accessed as well as the underlying original linked resource reference. In the example shown, the interstitial resources are accessed ˜15K times whereas the original linked resource reference is accessed only ˜2 k times. In some embodiments, the click counts are summarized and/or rounded values and additional details including specific counts and additional metrics can be displayed and/or accessed from the user interface view. In the bottom dialog view, additional user click interaction data is displayed including specific users that have accessed the interstitial resources and the underlying original linked resource references. The detailed metrics can include user identifiers, user roles, message click count metrics, and details of the identified linked resource references such as domain names, among other metrics or metadata. In some embodiments, the bottom dialog view is a summary of the top users who have received and/or interacted with malicious linked resource references.

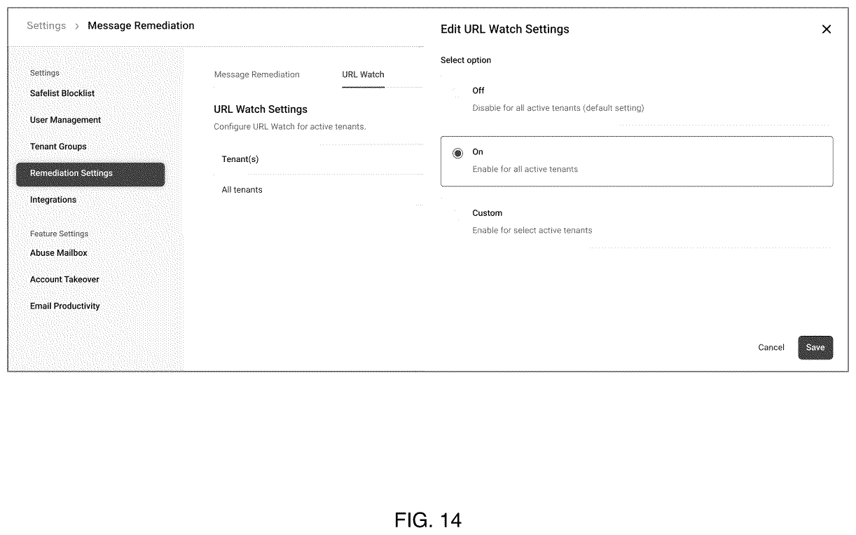

FIG. 14 is an example of a user interface view for configuring threat detection analysis for malicious linked resource references in messages. The user interface view of FIG. 14 shows example configuration options for identifying malicious linked resource references in messages. In some embodiments, the configuration page is self-serviceable by users and/or may be utilized by an administrator for an organization. In the example shown, the threat detection analysis can be enabled for all active tenants, disabled for all active tenants, or enabled for a select set of active tenants. For example, a set of tenants can be selected based on user identifier, hardware and/or software platform, organizational sub-group, past history, past behavior, security risk level, group category, and/or one or more other selection criteria. In some embodiments, the user interface view of FIG. 14 corresponds to threat detection steps performed by a message threat detection service such as message threat detection service 141 of FIG. 1 and/or message threat detection service 201 of FIG. 2 using one or more of the processes described with respect to FIGS. 3-8. In some embodiments, the threat detection results are for messages hosted by a messaging service such as messaging service 131 of FIG. 1.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving a message;
identifying one or more linked resource references included in the message;
for a specific linked resource reference included in the one or more linked resource references, determining a threat score based at least in part on one or more attributes of the specific linked resource reference;
determining that the threat score satisfies a replacement criterion;
replacing for the message the specific linked resource reference with a replacement linked resource reference to an interstitial resource;
tracking one or more user interactions with the replacement linked resource reference; and
performing a security action based on the tracked one or more user interactions.

2. The method of claim 1, wherein the one or more attributes of the specific linked resource reference are based on one or more of the following associated with the specific linked resource reference: a domain name, a keyword, a use of a reference shortener, a use of authentication, an authentication type, or a past knowledge of the specific linked resource reference.

3. The method of claim 1, wherein the one or more attributes of the specific linked resource reference are based on one or more of the following associated with the message: a message subject, a message header, an Internet Protocol (IP) address, message text, or an attachment.

4. The method of claim 1, wherein the threat score includes at least a risk score component and an abnormality score component.

5. The method of claim 1, wherein determining that the threat score satisfies the replacement criterion includes comparing the one or more attributes of the specific linked resource reference against one or more reference criteria.

6. The method of claim 1, wherein comparing the one or more attributes of the specific linked resource reference against the one or more reference criteria includes applying one or more logical operations to a set of the one or more attributes.

7. The method of claim 1, wherein tracking the one or more user interactions with the replacement linked resource reference includes tracking one or more of the following: an identity of a visiting user, a time of a visit to the interstitial resource by the visiting user, an access by the visiting user to the specific linked resource reference from the interstitial resource, or a time of an access to the specific linked resource reference from the interstitial resource by the visiting user.

8. The method of claim 1, further comprising:
receiving a request to the interstitial resource; and
in response to the request to the interstitial resource, providing information on the linked resource reference.

9. The method of claim 8, wherein the provided information includes a description of a security threat associated with the linked resource reference.

10. The method of claim 8, wherein the provided information includes a description of one or more security threat characteristics associated with the linked resource reference.

11. The method of claim 8, wherein the provided information includes a reference to the specific linked resource reference accessible from the interstitial resource.

12. A system, comprising:
one or more processors; and
a memory coupled to the one or more processors, wherein the memory is configured to provide the one or more processors with instructions which when executed cause the one or more processors to:
receive a message;
identify one or more linked resource references included in the message;
for a specific linked resource reference included in the one or more linked resource references, determine a threat score based at least in part on one or more attributes of the specific linked resource reference;
determine that the threat score satisfies a replacement criterion;
replace for the message the specific linked resource reference with a replacement linked resource reference to an interstitial resource;
track one or more user interactions with the replacement linked resource reference; and
perform a security action based on the tracked one or more user interactions.

13. The system of claim 12, wherein the one or more attributes of the specific linked resource reference are based on one or more of the following associated with the specific linked resource reference: a domain name, a keyword, a use of a reference shortener, a use of authentication, an authentication type, or a past knowledge of the specific linked resource reference.

14. The system of claim 12, wherein the one or more attributes of the specific linked resource reference are based on one or more of the following associated with the message: a message subject, a message header, an Internet Protocol (IP) address, message text, or an attachment.

15. The system of claim 12, wherein the threat score includes at least a risk score component and an abnormality score component.

16. The system of claim 12, wherein determining that the threat score satisfies the replacement criterion includes comparing the one or more attributes of the specific linked resource reference against one or more reference criteria.

17. The system of claim 12, wherein comparing the one or more attributes of the specific linked resource reference against the one or more reference criteria includes applying one or more logical operations to a set of the one or more attributes.

18. The system of claim 12, wherein to track the one or more user interactions with the replacement linked resource reference includes one or more of the following: to track an identity of a visiting user, a time of a visit to the interstitial resource by the visiting user, an access by the visiting user to the specific linked resource reference from the interstitial resource, or a time of an access to the specific linked resource reference from the interstitial resource by the visiting user.

19. The system of claim 12, wherein the memory is further configured to provide the one or more processors with instructions which when executed cause the one or more processors to:
receive a request to the interstitial resource; and
in response to the request to the interstitial resource, provide information on the linked resource reference including a reference to the specific linked resource reference accessible from the interstitial resource.

20. A computer program product, the computer program product being embodied in a non-transitory computer readable storage medium and comprising computer instructions for:
receiving a message;
identifying one or more linked resource references included in the message;
for a specific linked resource reference included in the one or more linked resource references, determining a threat score based at least in part on one or more attributes of the specific linked resource reference;
determining that the threat score satisfies a replacement criterion;
replacing for the message the specific linked resource reference with a replacement linked resource reference to an interstitial resource;
tracking one or more user interactions with the replacement linked resource reference; and
performing a security action based on the tracked one or more user interactions.
